(19) United States
(12) Patent Application Publication
(10) Pub. No.: US 2004/0161689 A1
(43) Pub. Date: Aug. 19, 2004

(54) High density digital data recording

(76) Inventor: Stephen Po-Ming Cheng, Concord (CA)

Correspondence Address: Mr. Stephen Cheng, 142 Spyglass Hill Road, Concord, ON, L4K 2K7, CA

(21) Appl. No.: 10/365,142

(22) Filed: Feb. 13, 2003

(51) Int. Cl. G03G 13/20

(52) U.S. Cl. 430/124

(57) ABSTRACT

A method of producing an electrostatic charge image comprising the sequential steps of: (1) bringing an electrode into proximity with a photoreceptor, the photoreceptor having a dielectric substrate and a photoconductive film intimately bonded to the substrate, the electrode having means to enable an electric field to be applied across the photoreceptor and being adapted to be brought into proximity with the substrate of the photoreceptor along a length of the electrode and charging the photoreceptor with an electrostatic charge of one polarity and projecting a blanket of light on the receptor, (2) charging the photoreceptor with an electrostatic charge of opposite polarity, and (3) projecting a modulated scanning beam of “on” and “off” light pulses on the photoreceptor whereby an electrostatic charge image of digital data is formed on the photoconductor surface. During development the back electrode is peeled off from the back of the photoreceptor. This tends to increase the electric field intensity inside the development system. Because of the strong electric field inside the development system extremely high resolution can be achieved. The developed image can then be transferred onto a strip of tape and fixed thereon.

### FIELD OF THE INVENTION

This invention relates to photoreproduction using the system known as electrophotography.

In the electrophotographic system a latent electrostatic image is created on a photoconductor surface to which charged toner material is subsequently applied, transforming the electrostatic image into a visual image. The toner is then transferred onto a sheet and fused to it. To create the electrostatic image the subject is first projected onto a charged photoreceptor which receives the latent image as a charge density varying over its surface according to the light intensity projected by the subject, the area receiving less light having a higher charge density. This charge density image is developed by applying charged toner material and the toner material is transferred to a charged dielectric sheet.

It is an object of the present invention to provide a method and apparatus for obtaining photoreproduction having an electrostatic field of increased strength, allowing the use of toner particles of smaller size and therefore as reproduction of finer grain and resolution.

### SUMMARY OF THE INVENTION

In U.S. Pat. No. 4,756,992 I disclosed an electrophotographic system to reproduce full tone image. The present invention is a continuous development of my previous invention to be applied to high density digital data recording.

Essentially the invention consists of a method of producing an electrostatic charge image comprising the sequential steps of: (1) bringing an electrode into proximity with a photoreceptor, the photoreceptor having a dielectric substrate and a photoconductive film intimately bonded to the substrate, the electrode having means to enable an electric field to be applied across the photoreceptor and being adapted to be brought into proximity with the substrate of the photoreceptor along a length of the electrode and charging the photoreceptor with an electrostatic charge of one polarity and projecting a blanket of light on the photoreceptor, (2) charging the photoreceptor with an electrostatic charge of opposite polarity, and (3) projecting a modulated scanning beam of “on” and “off” light pulses on the photoreceptor whereby an electrostatic charge image of high density digital data is formed on the photoconductor surface.

### BRIEF DESCRIPTION OF THE DRAWINGS

An example embodiment of the invention is shown in the accompanying drawings in which:

FIG. 1 is a cross-sectional view of a photoreceptor and electrode;

FIG. 2a is a schematic diagram of the first step in photoreproduction using the photoreceptor and electrode of FIG. 1;

FIG. 2b is a schematic diagram showing the migration of negative charge to the interface in the photoreceptor;

FIG. 2c is a schematic diagram showing the relative distribution of charge density effected by the step of FIG. 2a;

FIG. 3a is a schematic diagram showing the second step in photoreproduction using the photoreceptor and electrode of FIG. 1;

FIG. 3b is a schematic diagram showing the relative distribution of charge density effected by the step of FIG. 3a;

FIG. 4a is a schematic diagram showing the third step in photoreproduction using the photoreceptor and electrode of FIG. 1;

FIG. 4b is a schematic diagram showing the relative distribution of charge density effected by the step of 4a;

FIG. 5 is a schematic diagram showing the fourth step in photoreproduction using the photoreceptor and electrode of FIG. 1;

### DESCRIPTION OF PREFERRED EMBODIMENTS

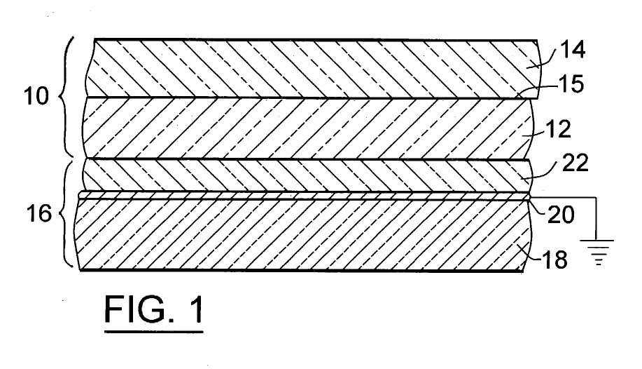

The example embodiment shown in FIG. 1 of the drawings comprises (a) a photoreceptor 10 having a dielectric substrate 12 and a photoconductive film 14 intimately bonded to the substrate with an interface 15, and (b) an electrode 16 having a lower belt 18 of flexible material, an intermediate conductive film 20 intimately bonded to belt 18 and grounded, and an upper layer 22 of dielectric material bonded to film 20. Photoreceptor 10 and electrode 16 are capable of being brought into intimate contact as shown in FIG. 1 and the following material and thickness are preferred:

| element | material | thickness |
|---|---|---|
| substrate 12 | polyester | 25-150 um |
| | (Mylar, Teflon) | |
| film 14 | amorphous silicon | 25-150 um |
| | (a-Si:H) | |
| belt 18 | polyester | |
| | (Mylar, Teflon, aluminum) | |
| film 20 | Al, CuI | 100-500 Angstroms |
| layer 22 | Si₃N₄, polyester (Mylar, Teflon) | 1000 Angstroms-5 um |

If belt 18 is made of a conductive metal such as aluminum, intermediate conductive film 20 may be omitted.

High density digital data can be recorded in the form of parallel tracks along a long narrow strip of a cassette tape. The tracks are only 1.5 microns apart, similar in size to the compact disc tracks commonly found on the market. The dark areas correspond to the ‘0’ bits and the transparent areas correspond to the ‘1’ bits. Since digital data averages an equal number of ‘on’ and ‘off’ bits, taking into consideration the space between the tracks and the space between bits, a ‘pre-selected’ charge density to be injected into the interface between the photoconductive film and the substrate can be determined.

The pre-selected charge density to be injected into the interface can be calculated as follows:

for a positive image,

Pre-selected Injected Charge Density=Surface Charge Density (1−B)/2

for a negative image,

Pre-selected Injected Charge Density=Surface Charge Density (1+B)/2.

B represents the percentage of space between tracks plus the percentage of space between bits in one unit area. A positive image means the space between the tracks and the space between bits will be developed. A negative image means these areas will be left clear.

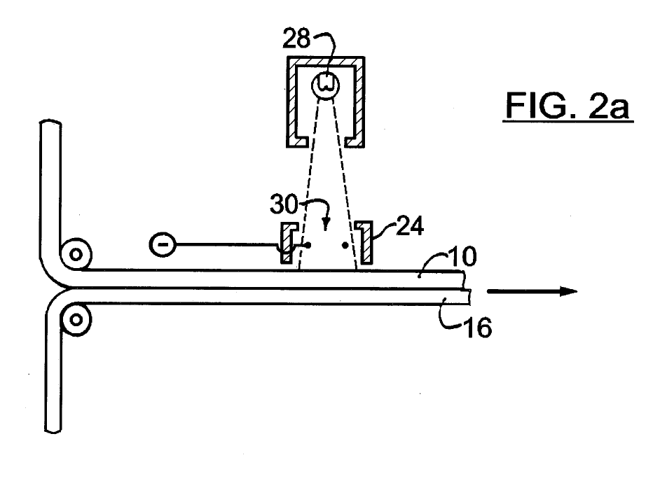

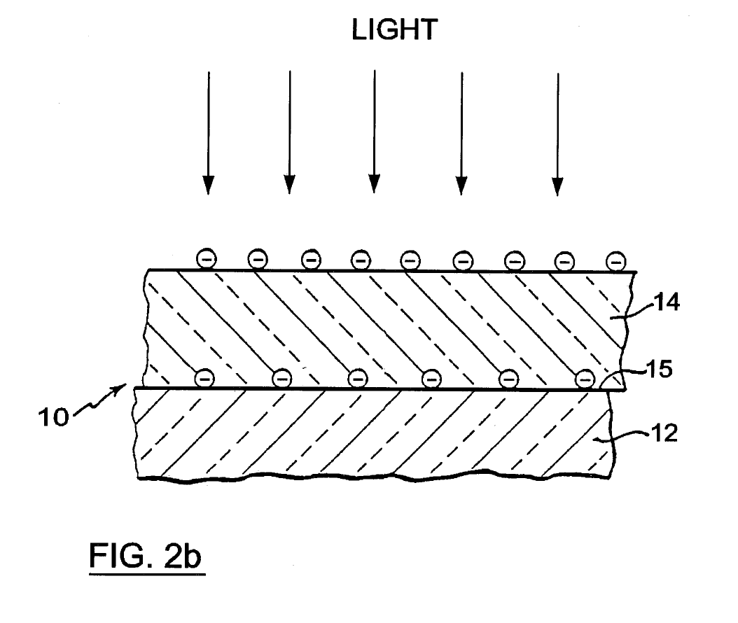

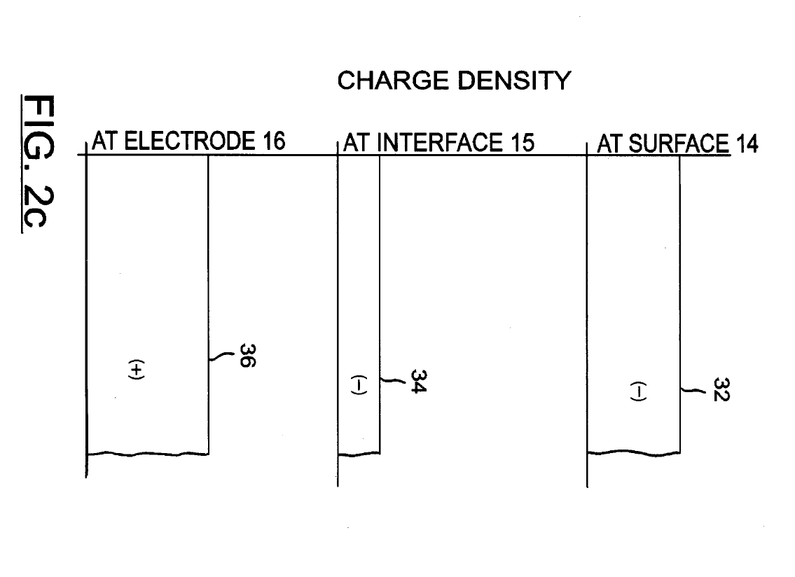

An example embodiment of the method of the invention is shown in FIGS. 2 to 5 of the drawings. In the first step of the example method photoreceptor 10, together with electrode 16, is passed beneath a corona charge station 24 which is connected to a source of negative electrical potential. A blanket of light is projected by a light source 28 onto the photoconductive film 14 of photoreceptor 10 through an opening 30 in the corona charge station 24 as seen in FIG. 2a. The result of this projection is the migration of negative ions, through film 14 to interface 15 where the negative charge is trapped, as seen in FIG. 2b. In FIG. 2c, the relative distribution of the charge density is indicated at the surface of film 14 (negative) by numeral 32, at interface 15 (negative) by numeral 34 and in electrode 16 (positive) by numeral 36, the positive charge distribution in electrode 16 being induced by the negative charge at interface 15 and at surface of film 14. A pre-selected charge is injected into the interface.

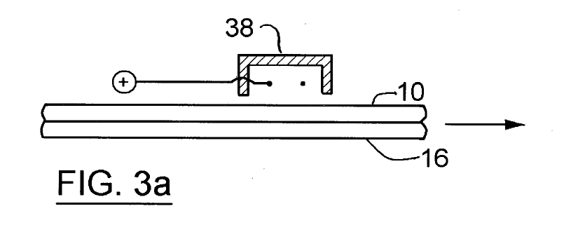

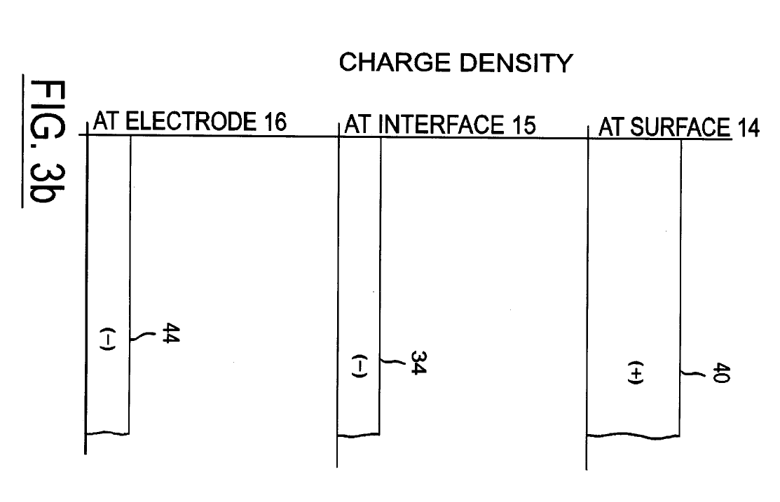

In the next step photoreceptor 10, together with electrode 16, is passed beneath a corona charge station 38 which is connected to a source of positive electrical potential, as seen in FIG. 3a, resulting in a relative distribution of charge density as seen in FIG. 3b, which shows a positive charge 40 at the surface of film 14, the same negative charge 34 at interface 15 and a negative charge 44 at electrode 16.

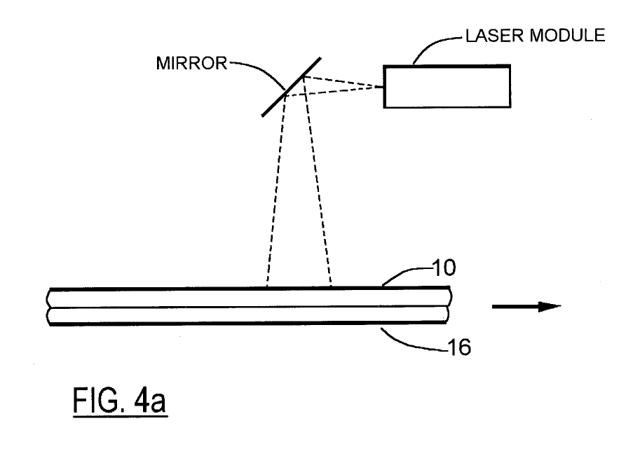

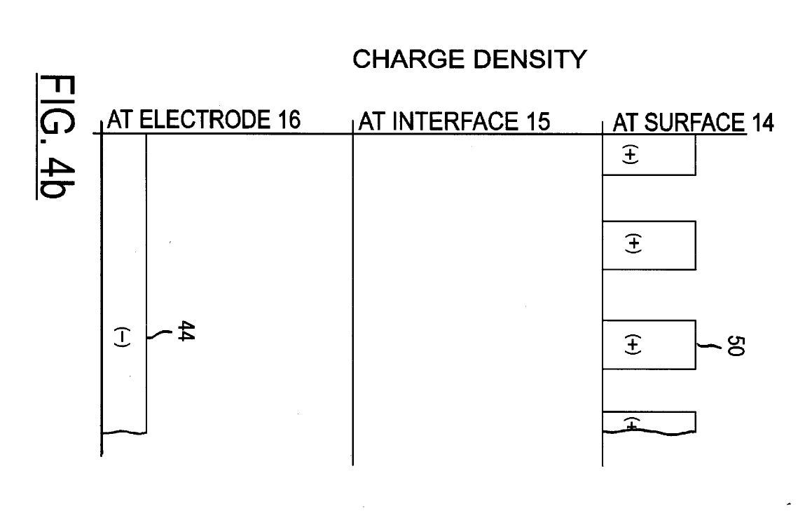

In the next step photoreceptor 10 and electrode 16 are passed beneath a laser module. A modulated scanning laser beam writes ‘on’ and ‘off’ light pulses onto the photoconductor surface as seen in FIG. 4a. Positive ions migrate through the photoconductor layer 14 to the interface when the laser is at the ‘on’ stage and no charge migration at the ‘off’ stage. The result of this is that there is positive charge remains on the photoreceptor surface in the ‘off’ areas, corresponding to the ‘0’ bits, and no charge in the ‘on’ areas, corresponding to the ‘1’ bits. A high density digital data charge image is formed on the photoconductor layer 14. The relative distribution of charge density is seen in FIG. 4b, which shows a positive charge image 50 on the surface of film 14. Because it averages equal numbers of ‘0’ and ‘1’ in the digital data, an exact amount of positive ions will migrate down to neutralize the pre-selected negative charge trapped at the interface. Therefore there will be no charge at the interface 15. Induced charge 44 at the electrode remains unaffected.

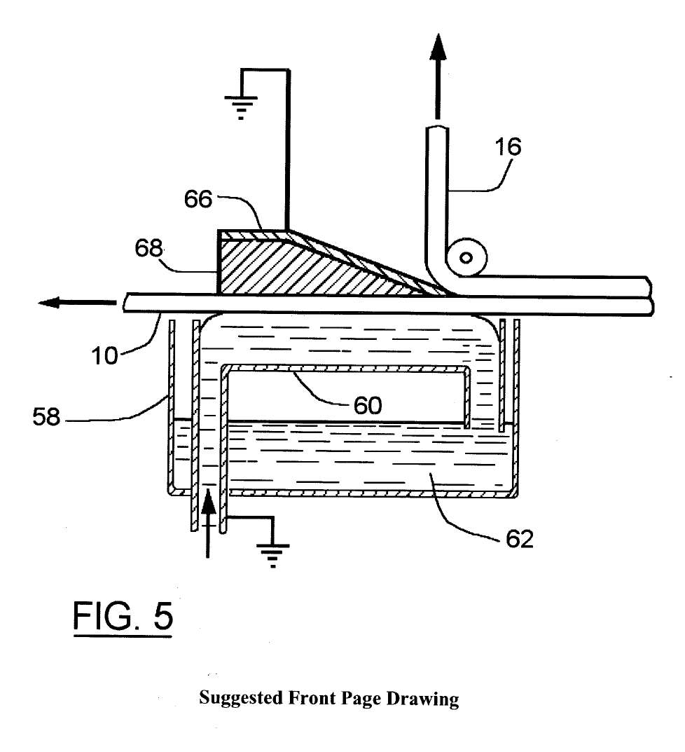

After photoreceptor 10 is given its exposure to the high density digital data image, as described with respect to FIG. 4, toner material is applied in known manner as shown in FIG. 5. A developer housing 58 encloses a imager 60 which delivers liquid developer 62 consisting of positively charged carrier and negatively charged toner particles of 0.1 micron in size (preferred) to film 14 of photoreceptor 10. The grounded metal casing of imager 60 is used as a development electrode.

As electrode 16 is peeled off from the back of substrate 12 it is replaced by a solid plastic support 68, which carries conductive electrode 66 at its outer surface. Support 68 is slightly conductive, about 10⁵ ohm-cm, so that any static charge accumulated by rubbing against substrate 12 is discharged. As photoreceptor 10 moves down, the charge latent image surface moves further and further away from electrode 66. This tends to increase the electric field intensity inside the development system. However, on the other hand, the deposition of toner particles on the image surface tends to decrease the electric field intensity. By suitably designing the angle of the edge of support 68 it is possible to achieve a condition that the increase in field intensity is exactly balanced by the decrease caused by the deposition of toner particles. As a result the electric field intensity is kept constant inside the development system. This prevents an excessive strong electric field buildup inside the development system which would cause “arcing” between the image charge and the metal casing of imager 60. At the end of the development procedure the latent image charge is complete neutralized by the deposited toner particles. The developed toner image can then be transferred to a strip of tape and fixed.

It can be seen that the function of conductive layer 20 is to enable an electric field to be applied across photoreceptor 10 and the function of dielectric layer 22 is to prevent charge ions from being attached to the substrate when the electrode is peeled away.

Because of the strong electric field inside the development system extremely high resolution can be achieved. A scanning laser or an optical projecting device can read the digital data on the tape. This compact tape can be used for audio, video and computer data. Because of the high density, a movie in the high definition format of 25 GB can be stored in one 90 m long and 9 mm wide cassette tape. The cassette size will be 15×65×100 mm.

Some photoreconductive materials, for example selenium, conduct positive charges when light activated. This required for light impingement from underneath in the pre-selected charge injection step. In this case a blanket of light is projected on photoreceptor 10 from underneath, thus causing the positive ions to migrate to the upper surface of film 14, leaving behind a negative charge density as seen in FIG. 2b. In this case both electrode 16 and substrate 10 are made of transparent material.

Bipolar photoconductors are most suitable for this invention. The common bipolar photoconductors are amorphous silicon (a—Si:H), ZnO treated with urazole or H.sub.2 S, or its resin containing Mn or other additives, various organic photoconductors containing certain substituted cycloheptenyl compounds and organic photoconductors comprising a halogen-ketone-formaldehyde resin. Single-polar photoconductors such as amorphous selenium (as mentioned above) and most organic photoconductors can also be used in this invention.

Of course the method of the invention may be carried out using a positive charge in the step of FIG. 2a followed by a negative charge in the steps of FIGS. 3a and 4a.

Of course the method of the invention may be carried out using other means to obtain a modulated scanning beam of “on” and “off” light pulses, such as using an array of light emitting diodes.

I claim:

1. A method of producing an electrostatic charge image of digital data comprising the sequential steps of:
(1) bringing an electrode into proximity with a photoreceptor, the photoreceptor having a dielectric substrate and a photoconductive film intimately bonded to the substrate, the electrode having means to enable an electric field to be applied across the photoreceptor and being adapted to be brought into proximity with the substrate of the photoreceptor along a length of the electrode and charging the photoreceptor with an electrostatic charge of one polarity and projecting a blanket of light on the photoreceptor, (2) charging the photoreceptor with an electrostatic charge of opposite polarity, and (3) projecting a modulated scanning beam of “on” and “off” light pulses on the photoreceptor whereby an electrostatic charge image of digital data is formed on the photoconductor surface.

2. A method of producing an electrostatic charge image as claimed in claim 1 including the step of: (4) moving the electrode away from the photoreceptor, whereby to increase the electric field above the photoconductor surface.

3. A method as claimed in claim 1 in which said one polarity is negative and said opposite polarity is positive.

4. A method as claimed in claim 1 in which said one polarity is positive and said opposite polarity is negative.

5. A method as claimed in claim 1 in which both the substrate of the photoreceptor and the electrode are transparent and including the step of projecting a blanket of light on the electrode.

6. A method as claimed in claim 1 including the additional steps of:
(4) moving the electrode away from the photoreceptor and applying particulate toner material carrying a charge of said one polarity to the photoconductive film of the photoreceptor, (5) charging a strip of material with an electrostatic charge of said opposite polarity and applying the strip to the photoconductive film of the photoreceptor, (6) removing the strip from the photoreceptor, and (7) fixing the toner material on the strip whereby the reproduction of the digital data is fixed thereon.

7. In an electrostatic image apparatus of reproduction of digital data:
(a) a photoreceptor having a dielectric substrate and a photoconductive film intimately bonded to the substrate:
(b) An electrode having means to enable an electric field to be applied across the photoreceptor and being adapted to be brought into proximity with the substrate of the photoreceptor along a length of the electrode;
means sequentially (1) to bring the electrode into proximity with the photoreceptor and to inject a charge of even density of one polarity to the interface between the photoconductive film and the substrate, (2) to charge the photoreceptor with an electrostatic charge of opposite polarity, and (3) to project a modulated scanning beam of “on” and “off” light pulses on the photoreceptor whereby an electrostatic charge image of digital data is formed on the photoconductor surface.

8. In an electrostatic image apparatus of reproduction of electrostatic charge image of digital data as claimed in claim 7 in which a pre-selected charge density is injected to the interface between the photoconductive film and the substrate.

9. An electrostatic image apparatus of photographic reproduction of digital data as claimed in claim 7 including (4) means to move the electrode away from the photoreceptor, whereby to increase the electric field above the photoconductor surface.

10. An apparatus as claimed in claim 7 in which said one polarity is negative and said opposite polarity is positive.

11. An apparatus as claimed in claim 7 in which said one polarity is positive and said opposite polarity is negative.

12. An apparatus as claimed in claim 7 in which the substrate of the photoreceptor and the electrode are transparent, and including means to project a blanket of light on the electrode.

13. An electrostatic image apparatus of photographic reproduction of digital data comprising:
(a) a photoreceptor having a dielectric substrate and a photoconductive film intimately bonded to the substrate;
(b) An electrode having means to enable an electric field to be applied across the photoreceptor and being adapted to be brought into proximity with the substrate of the photoreceptor along a length of the electrode;
means sequentially (1) to bring the electrode into proximity with the photoreceptor and means to inject a charge of even density of one polarity to the interface between the photoconductive film and the substrate, (2) to charge the photoreceptor with an electrostatic charge of opposite polarity, (3) to project a modulated scanning beam of “on” and “off” light pulse on the photoreceptor, (4) to move the electrode away from the photoreceptor and to apply particulate toner material carrying a charge of said one polarity to the photoconductive film of the photoreceptor, (5) to charge a strip of material with an electrostatic charge of said opposite polarity and to apply the strip to the photoconductive film of the photoreceptor, (6) to remove the strip from the photoreceptor, and (7) to fix the toner material on the strip whereby the reproduction of the photographic digital data image is fixed thereon.

14. An apparatus as claimed in claim 13 in which said one polarity is negative and said opposite polarity is positive.

15. An apparatus as claimed in claim 13 in which said one polarity is positive and said opposite polarity is negative.

16. An apparatus as claimed in claim 13 in which the substrate of the photoreceptor and the electrode are transparent, and including means to project a blanket of light on the electrode.
